(19) United States
(12) Patent Application Publication
(10) Pub. No.: US 2010/0131541 A1
(43) Pub. Date: May 27, 2010

(54) SIMULTANEOUS SEARCHING USING MULTIPLE SEARCH ENGINES VIA CLIENT APPLICATION

(76) Inventor: John Lee, Fort Lauderdale, FL (US)

Correspondence Address: MARK TERRY, ESQ., 801 BRICKELL AVE., SUITE 900, Miami, FL, 33131, US

(21) Appl. No.: 12/276,635

(22) Filed: Nov. 24, 2008

(51) Int. Cl. G06F 17/30; G06F 7/00

(52) U.S. Cl. 707/765; 707/E17.014; 707/E17.032

(57) ABSTRACT

A method for facilitating the simultaneous initiation of a search on a plurality of search engines available over a network can be provided. The method can include receiving from a server a first program logic configured for providing an interface and executing the first program logic. The method can further include reading from the interface a search parameter for conducting a search on a plurality of search engines and generating a data construct including a second program logic. The method can further include executing the second program logic, sending a separate request to each of the plurality of search engines to conduct a search and sending the search parameter to an ad server. The method can further include receiving search results from the search engines and at least one ad from the ad server. The method can further include displaying the search results and the at least one ad.

### BACKGROUND OF THE INVENTION

1. Field of the Invention

The present invention relates to the field of software and more particularly to software that facilitates network searching and network navigation.

2. Description of the Related Art

Computer-based search engines are well known in the art. Typically a search engine comprises a software application that is executed on a data processing system and includes a user interface and a database of information that is stored on a memory component associated to or accessible by the data processing system. The information (data, documents, articles, etc.) within the database is made accessible to a user via the user interface of the data processing system. The user enters a search query in the user interface and submits the query to the search engine/application for processing. The search engine parses the query into search keys and uses those keys to access a set of keywords associated with various articles which can be retrieved. When the query is received, the search engine compares the search terms with the keywords within articles in the database and determines whether the entered search terms match (or are found within) any of the documents within the database. When a match is found, a list of the documents that matches the search terms is returned or output to the user.

With the emergence of the web and large intranets, search engines have migrated online. These search engines are referred to as network search engines. Because different network search engines use different indexing and ranking techniques, users of search engines often desire to use multiple search engines so to effectuate an exhaustive search of a network. This usually entails opening a first web browser to utilize a first search engine, effectuating a search on the first search engine and then navigating the results of the first search engine. Next, the user opens a second web browser to utilize a second search engine, effectuating a search on the second search engine and then navigating the results of the second search engine. The user then re-executes the same sequence of steps for each additional search engine until all desired search engines have been evaluated.

The lengthy series of steps described above comes with drawbacks. This process can be time-consuming and tedious for the user. Furthermore, the process of opening separate web browsers initiating separate searches can be distracting to the user and cause a large processing burden upon the user's computer. The result of the steps described above is that the user is left with multiple open web browsers, wherein each web browser may be left at a different stage in the browsing process. Multiple open web browsers on one user desktop can be confusing to the user. Further, the user may not remember which search engine corresponds to each web browser and at what stage of browsing each web browser was left.

Another problem encountered by users of web browsers involves the sending of links. Often times, users desire to send other users a list of links to a set of web sites of network locations. For example, a teacher may desire to send a student a list of ten web sites that are useful for learning about a separate subject. In this example, the teacher amasses Universal Resource Locators (URLs) for each web site and writes them into an email or authors them onto a web page. Then, the student receives the email including the ten URLs or opens up the pertinent web page that includes the ten URLs. Subsequently, the student clicks on the first URL, which opens a first web browser that navigates to the site of the first URL, and the student proceeds to web surf on the site of the first URL. Next, the student clicks on the second URL, which opens a second web browser that navigates to the site of the second URL, and the student proceeds to web surf on the site of the second URL. The student then re-executes the same sequence of steps for each additional URL until all ten URLs have been visited.

Like the previous problem regarding search engines, the lengthy series of steps described above comes with drawbacks. This process can be time-consuming and tedious for the user, in addition to distracting to the user and detrimental to the user's computer due to the large processing burden. Again, the user is left with multiple open web browsers, wherein each web browser may be left at a different stage in the browsing process. This can confuse the user, the user may not remember which URL corresponds to each web browser and at what stage of browsing each web browser was left.

Therefore, there is a need to overcome the deficiencies with the prior art and more particularly for a more efficient way to conduct searches on multiple network search engines and a more efficient way to navigate network sites.

### BRIEF SUMMARY OF THE INVENTION

Embodiments of the present invention address deficiencies of the art in respect to online searching and provide a novel and non-obvious method, system and computer program product for searching using multiple search engines. In an embodiment of the invention, a method for facilitating the simultaneous initiation of a search on a plurality of search engines available over a network can be provided. The method can include receiving from a server a first program logic configured for providing an interface and executing the first program logic, thereby generating the interface. The method can further include reading from the interface a search parameter for conducting a search on a plurality of search engines and generating a data construct including a second program logic. The method can further include executing the second program logic and responsive to executing the second program logic, sending a separate request to each of the plurality of search engines to conduct a search as defined by the search parameter and sending the search parameter to an ad server. The method can further include receiving search results from each of the plurality of search engines and receiving from the ad server at least one ad corresponding to the search parameter. The method can further include displaying the search results and the at least one ad in a second interface.

In another embodiment of the invention, a computer program product comprising a computer usable medium embodying computer usable program code for facilitating the simultaneous initiation of a search on a plurality of search engines available over a network can be provided. The computer program product can include computer usable program code for receiving from a server a first program logic configured for providing an interface and executing the first program logic, thereby generating the interface. The computer program product can further include computer usable program code for reading from the interface a search parameter for conducting a search on a plurality of search engines and generating a data construct including a second program logic. The computer program product can further include computer usable program code for executing the second program logic and, responsive to executing the second program logic, sending a separate request to each of the plurality of search engines to conduct a search as defined by the search parameter and sending the search parameter to an ad server. The computer program product can further include computer usable program code for receiving search results from each of the plurality of search engines and receiving from the ad server at least one ad corresponding to the search parameter. The computer program product can further include computer usable program code for displaying the search results and the at least one ad in a second interface.

In another embodiment of the invention, a method for facilitating the simultaneous initiation of a plurality of web sites available over a network can be provided. The method can include receiving from a server a first program logic configured for providing an interface and executing the first program logic, thereby generating the interface. The method can further include reading from the interface a plurality of URLs and generating a data construct including a second program logic, wherein the second program logic includes instructions for sending a separate request to each of the plurality of URLs. The method can further include sending the data construct to a client for execution of the second program logic.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a block diagram illustrating a network architecture of a system for providing simultaneous searching using multiple search engines and for providing transmission of an activation of multiple web sites, in accordance with one embodiment of the present invention;

FIG. 2 is an illustration of a web browser providing a system for providing simultaneous searching using multiple search engines and for providing transmission of an activation of multiple web sites, in accordance with one embodiment of the present invention;

FIG. 3 is a block diagram showing the data flow of a process for providing simultaneous searching using multiple search engines, in accordance with one embodiment of the present invention;

FIG. 4 is an illustration of a web browser providing a system for providing transmission of an activation of multiple web sites, in accordance with one embodiment of the present invention;

FIG. 5 is a block diagram showing the data flow of a process for providing transmission of an activation of multiple web sites, in accordance with one embodiment of the present invention.

### DETAILED DESCRIPTION OF THE INVENTION

The present invention address deficiencies of the art in respect to online searching and provide a novel and non-obvious method, system and computer program product for simultaneously searching multiple search engines. The present invention provides a robust standalone program that reads search parameters entered by a user into an interface, such as a web browser, and automatically creates a data construct including program logic that initiates a simultaneous search of multiple search engines using the entered parameters. Upon execution of the program logic of the data construct, a simultaneous search of multiple search engines is initiated and the interface subsequently receives and displays the search results from the multiple search engines. Thus, a user must simply enter search parameters and press one button in an interface to initiate a search of multiple search engines and view the results. This eliminates the lengthy series of steps described above in connection with the conventional process of opening separate web browsers for initiating separate searches on multiple search engines.

The present invention further address deficiencies of the art in respect to online viewing of web sites and provide a novel and non-obvious method, system and computer program product for simultaneously viewing multiple web sites. The present invention provides a robust standalone program for creating a data construct that initiates multiple web sites in a single interface such as a web browser. The present invention allows a user to enter multiple URLs (representing multiple web sites) in an interface such as a web browser. Subsequently, a data construct including a program logic is generated. The data construct can then be sent to another client, such as via email. The recipient client may then execute the program logic of the data construct to simultaneously initiate the multiple URLs in an interface such as a web browser. Thus, a user must simply press one button or link in an interface to initiate multiple web sites previously defined by another user. This eliminates the conventional process of sending a list of URLs to another user, resulting in the lengthy series of steps described above in connection with the conventional process of opening separate web browsers for initiating separate web sites.

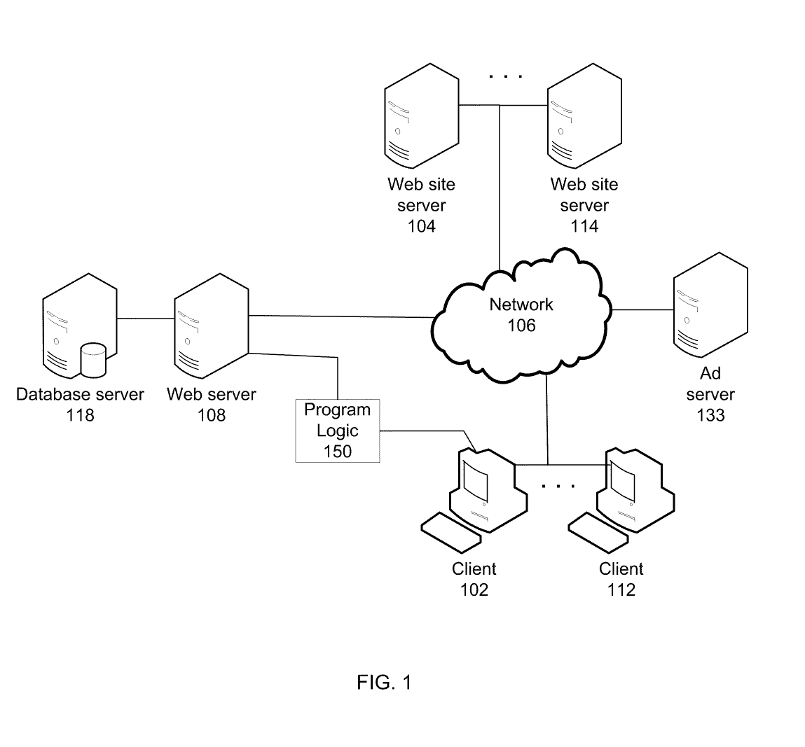

Referring now to the drawing figures in which like reference designators refer to like elements, there is shown in FIG. 1 an illustration of a block diagram showing the network architecture of a software application in accordance with the principles of the present invention. FIG. 1 shows an embodiment of the present invention wherein client users 102-112 interact with web servers 104-114, ad server 133 and web server 108 over a network 106, which can be a circuit switched network, such as the Public Service Telephone Network or a packet switched network such as the Internet.

FIG. 1 shows client users 102-112, web servers 104-114, ad server 133 and web server 108 connected to network 106 via computers, such as desktop personal computers, workstations or servers. Web server 108 includes a software engine that delivers applications to client computers 102-112. Ad server 133 includes a software engine that delivers ads to client computers 102-112 based on client information. It should be noted that although FIG. 1 shows only two client users 102-112, two web site servers 104-114 and one web server 108, the system of the present invention supports any number of client users, web site servers and servers connected via network 106.

In one embodiment of the present invention, the network application provided by the web server 108 of FIG. 1 is a client-server application having a client portion that resides on the computers of client users 102-112 and a server application that resides on web server 108. For example, the network application can be a web interface that is accessed by client users 102-112 via network 106. FIG. 1 further shows that web server 108 includes a database server 118. Client users 102-112 may also each include their own database. The database server 118 serves data from a database, which is a repository for data used by web server 108 and client users 102-112 during the course of operation.

FIG. 1 further shows program logic 150 comprising computer source code, scripting language code or interpreted language code that is compiled to produce computer instructions that perform various functions of the present invention. In one embodiment of the present invention, the program logic 150 is a scripting language such as ECMAScript, Cascading style sheets, XML, XSLT, Javascript, AJAX, XUL, JSP, PHP, and ASP. Program logic 150 may reside on a client 102, the web server 108 or any combination of the two.

Ad server 133 is a web server that stores advertisements and delivers them to clients, such as clients 102-112. The ad server 133 may also perform a variety of other tasks such as trafficking ads according to certain rules, targeting ads to a client based on predefined information about the client, reporting interactions with ads and fine tuning ads. Note that although ad server 133 is shown as a separate entity, the functions of ad server 133 may be integrated with another entity, such as server 108.

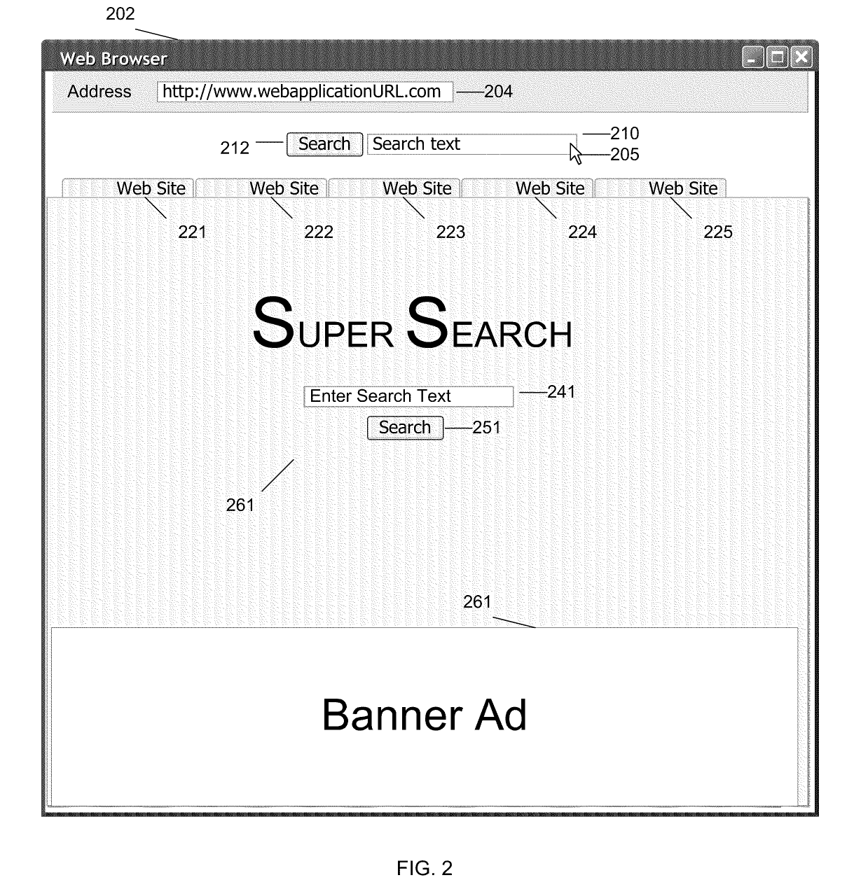

FIG. 2 is an illustration of a web browser 202 providing a system for providing simultaneous searching using multiple search engines and for providing transmission of an activation of multiple web sites, in accordance with one embodiment of the present invention. FIG. 2 shows that the web browser 202 includes an address text field 204 that indicates a Universal Resource Locator (URL) of a web site. Upon entering the appropriate URL, the web browser 202 sends a HyperText Transfer Protocol (HTTP) request for data to the appropriate web server, such as web server 108, corresponding to said URL. Subsequently, the web server 108 sends the appropriate web page data to the web browser 202. The web page data received by the web browser 202 may be HTML or may comprise some or all of the program logic 150, which may be a scripting language such as XML, XSLT, Javascript, etc. Upon receiving the web page data sent by web server 108, web browser 202 executes the web page data and thereby displays it as the interface shown in FIG. 2.

The term “search engine” is used to refer to any information search mechanism on a network-accessible machine. This includes a conventional search engine web site. This term also includes search mechanisms on web sites used for searching for items such as retail items.

Web browser 202 includes a text field 210 for the provision of search parameters and a button 212 for initiating a search based on the search parameters entered into text field 210. The user may place his mouse cursor 205 into the text field 210 to enter the desired search parameters and may use the mouse cursor 205 to press the button 212. After a search is initiated by entering search parameters into text field 210 and pressing button 212, the results of the various search engines are displayed in the multiple web pages represented by tabs 221-225.

FIG. 2 further shows that several tabs 221, 222, 223, 224 and 225 are shown wherein the first tab 221 is currently activated. That is, the page 261 corresponding to tab 221 is displayed while the web pages that correspond to tabs 221, 222, 223, 224 and 225 are not displayed as they are behind the active page 261. Each tab 221, 222, 223, 224 and 225 corresponds to results from a different search engine available over network 106. Page 261 provides a web page for the search engine corresponding to the search engine of tab 221. Page 261 provides a conventional text field 241 for the provision of search parameters and a button 251 for initiating a search based on the search parameters entered into text field 241. (Note that although tabs 221-225 are shown in FIG. 2, buttons or any other interface widget can alternatively be used interchangeably with tabs.)

A user navigating the web browser 202 may place the mouse cursor 205 over any tab to view the corresponding web page. For example, if the user desires to view the web page corresponding to tab 223, the user need only place the mouse cursor 205 over the tab 223. Additionally, if a user desires to initiate a search of additional search engines not represented by tabs 221-225, the user may press any tab 221-225 to display a drop down menu from which additional search engines are available. Upon pressing any of the available selections in the drop down menu, a search of the selected search engine would immediately be initiated using the same search parameters entered previously.

In one embodiment of the present invention, upon initiation of a search by entering search parameters into text field 210 and pressing button 212, the search parameters may also be sent to an ad server, such as ad server 133. The ad server may subsequently find an ad that corresponds to the search parameters and serve the ad to the client. The ad server may use a targeted advertising program that selects ads based on keywords entered by users as search terms in a search engine. Thus, along with displaying the results of the various search engines in the multiple web pages represented by tabs 221-225, an ad or ads (such as banner ad 261) served by the ad server 133 are also displayed in the multiple web pages represented by tabs 221-225.

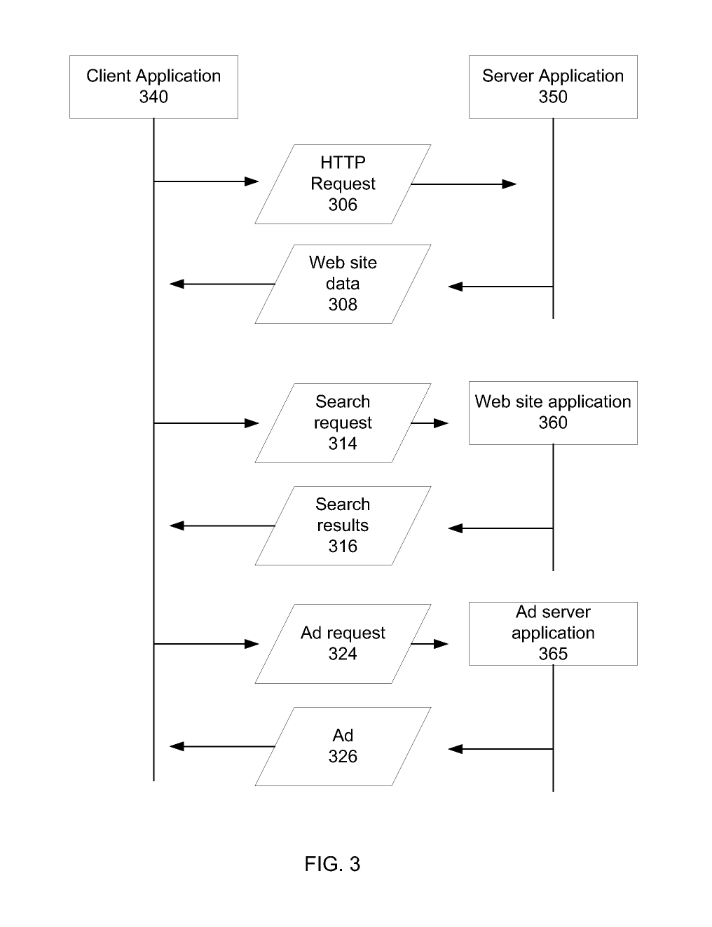

FIG. 3 is a block diagram showing the data flow of a process for providing simultaneous searching using multiple search engines, in accordance with one embodiment of the present invention. FIG. 3 shows a client application 340 corresponding to all or a portion of program logic 150 residing on a client computer such as client 102. The client application 340 may be a web browser, such as web browser 202, executing program logic 150. FIG. 3 further shows a server application 350 corresponding to all or a portion of program logic 150 residing on a server such as web server 108. FIG. 3 further shows a web server application 360 residing on a web server such as web server 104 and an ad server application 365 residing on an ad server such as ad server 133.

FIG. 3 shows that the client application 340 sends a request 306, such as an HTTP request, for data to the server application 350. The server application 350 sends the appropriate web page data 308, comprising HTML or a scripting code language file or data packet, to the client application 340. The web page data 308 received by the client application 340 is executed by the client application 340 and thereby displayed in an interface, such as shown in web browser 202.

Upon entering of search parameters by the user into the interface provided by web page data 308, the client application 340 generates a data construct 312 based on the received data. In one alternative, upon entering of search engine selections by the user into the interface provided by web page data 308, the search engine selections are figured into the data construct.

The data construct generated by the client application 340 includes computer instructions that, when executed by client application 340, send out a separate request, such as an HTTP request 314, to each search engine (i.e., web server application 360) selected by the user, wherein each request initiates a search on the respective search engine for the specified search parameters.

For example, if the user selected the search engines corresponding to tabs 221 and 222 and the user entered the search parameters “Abraham Lincoln” into the text field 210, then the data construct would include computer instructions that: 1) send out one HTTP request to the search engine corresponding to tab 221, wherein the HTTP request initiates a search for the search parameter “Abraham Lincoln,” and 2) send out one HTTP request to the search engine corresponding to tab 222, wherein the HTTP request initiates a search for the search parameter “Abraham Lincoln.”

In response to receiving the search requests 314, the web server application 360 for each web server 104-114 executes a search based on the search parameters in the request 314. The web server application 360 for each web server 104-114 generates a list of search results as a result of the executed search. Each web server application 360 for each web server 104-114 subsequently sends its search results (search results data 316), comprising HTML, a scripting code language file or data packet, to the client application 340. The search results data 316 received by the client application 340 is executed by the client application 340 and thereby displayed in the interface, such as web browser 202. Thus, the data flow of FIG. 3 describes how the web browser 202 is populated with the search results data 316 in response to a single press of the button 212.

As described above, the web browser 202 is populated with the search results data 316. Using the above example, wherein the user selected the search engines corresponding to tabs 221 and 222 and the user entered the search parameters “Abraham Lincoln” into the text field 210, tab 221 is populated with the search results of the first selected search engine and tab 222 is populated with the search results of the second selected search engine. Thus, the user of web browser 202 is able to simultaneously initiate a search on multiple search engines and, in response to one button press (button 212), receive and display the search results from the multiple search engines. Note that all selected tabs (i.e., selected search engines) receive search results at the same or substantially the same time. Although FIG. 2 shows that only one tab or page is displayed at one time, upon clicking of underlying tabs using the mouse cursor 205, the underlying tab (and its already-present search results) is displayed.

It should further be noted that although all selected tabs (i.e., selected search engines) receive search results at the same or substantially the same time, some tabs may be populated quicker than others due to a slow web site server. FIG. 2 shows that only one tab or page is displayed at one time, and therefore while one or more tabs are in the process of being populated or loaded due to a slow web site server, upon clicking of already-populated underlying tabs using the mouse cursor 205, the underlying tab (and its already loaded search results) can be displayed.

The simultaneous, or near simultaneous, population or loading of all of the tabs 221, 222, 223, 224 and 225 allows for quick and easy access to the page or pages displayed by each tab. As explained above, upon clicking of a tab using the mouse cursor 205, the tab (and its already-loaded search results) can be displayed. Tabs are not populated or loaded upon clicking of the tab but rather are loaded simultaneously or near-simultaneously when search results data 316 is received by the web browser 202. Therefore, after loading of the search results data 316, a user can expeditiously access any page displayed by a tab without having to wait for it to load.

In an embodiment of the present invention, upon entering of search parameters by the user into the interface provided by web page data 308, the client application 340 sends an ad request 324 to an ad server application 365 executing on ad server 133. The ad request 324 may simply be a copy of the search parameters entered by the user. The ad server 133 may subsequently find an ad that corresponds to the search parameters and serve the ad to the client. The ad server may use a targeted advertising program that selects ads based on keywords entered by users as search terms in a search engine. Subsequently, the ad server application 365 sends the selected ad 326 to the client application 340, which proceeds to display the ad 326 (such as banner ad 261) in the multiple web pages represented by tabs 221-225.

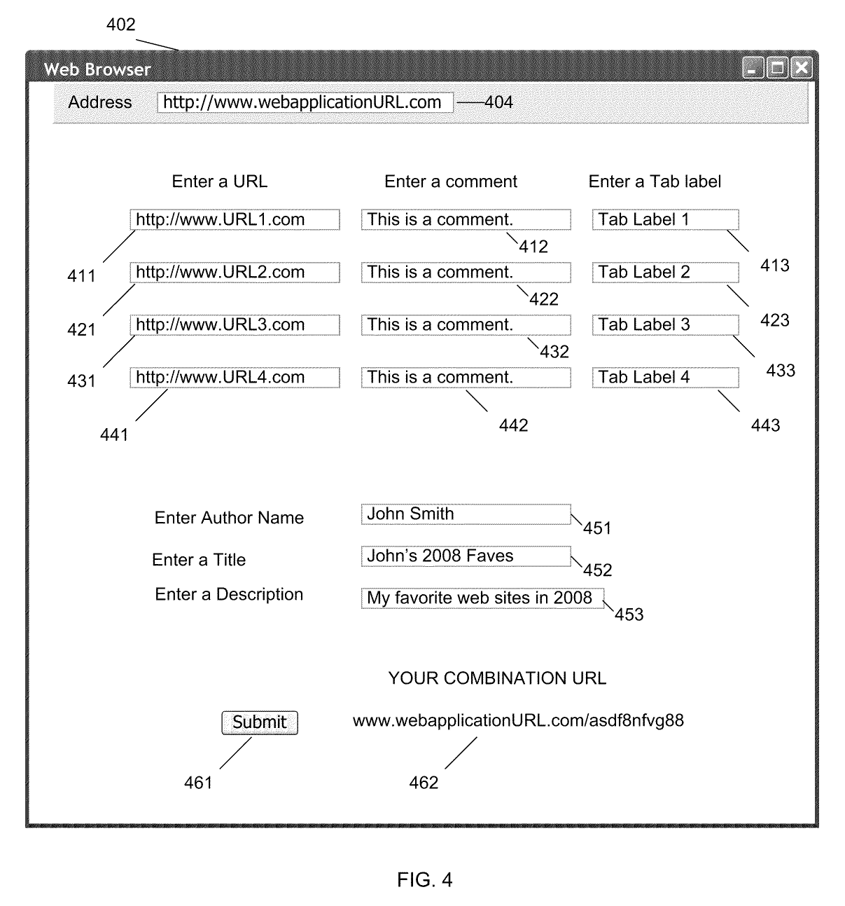

FIG. 4 is an illustration of a web browser 402 providing a system for providing transmission of an activation of multiple web sites, in accordance with one embodiment of the present invention. An activation of multiple web sites is a data construct or a set of program logic that, when executed, simultaneously initiates the automatic display of multiple enumerated web sites.

FIG. 4 shows that the web browser 402 includes an address text field 404 that indicates URL of a web site. Upon entering the appropriate URL, the web browser 402 sends an HTTP request for data to the appropriate web server, such as web server 108, corresponding to said URL. Subsequently, the web server 108 sends the appropriate web page data to the web browser 402. The web page data received by the web browser 402 may be HTML or may comprise some or all of the program logic 150, which may be a scripting language such as XML, XSLT, Javascript, etc. Upon receiving the web page data sent by web server 108, web browser 402 executes the web page data and thereby displays it as the interface shown in FIG. 4.

Web browser 202 includes various text fields 411, 421, 431 and 441 for the provision of URLs. For each URL text field 411, 421, 431 and 441, there is a corresponding comment text field, 412, 422, 432, 442, respectively, for the provision of a comments describing the URL. Also, for each URL text field 411, 421, 431 and 441, there is a corresponding tab label text field, 413, 423, 433, 443, respectively, for the provision of a tab labels describing the URL.

FIG. 4 further provides an author text field 451 for the provision of the name of the author of the activation of multiple web sites. A title text field 452 allows a user to enter a title for the activation and a description text field 453 allows a user to enter a description of the activation. A submit button 461 allows a user to submit the data entered into web browser 402 to the server 108, which replies with a URL 462 that is displayed in the web browser 402. The URL 462 provides a link or an address to a data construct or a set of program logic that, when executed, simultaneously initiates the automatic display of the web sites defined by the URLs entered by the user in URL text field 411, 421, 431 and 441.

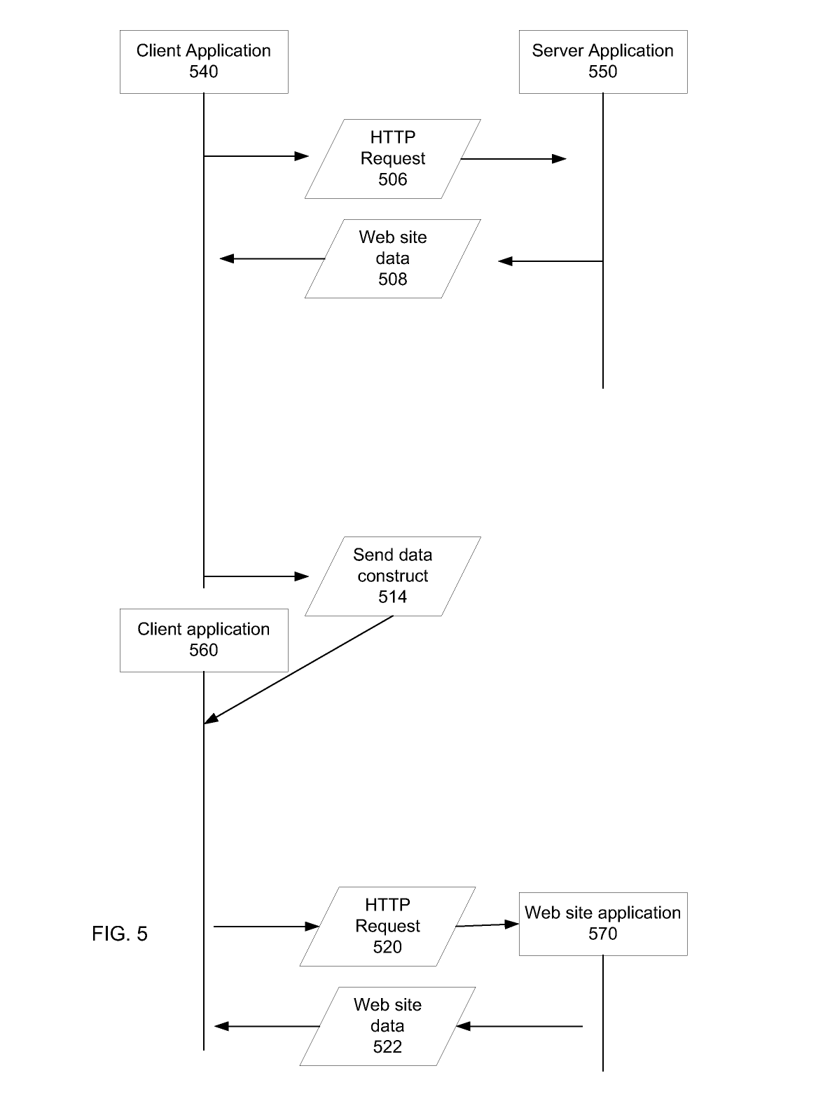

FIG. 5 is a block diagram showing the data flow of a process for providing transmission of an activation of multiple web sites, in accordance with one embodiment of the present invention. FIG. 5 shows a client application 540 corresponding to all or a portion of program logic 150 residing on a client computer such as client 102. The client application 540 may be a web browser, such as web browser 402, executing program logic 150. FIG. 5 further shows a server application 550 corresponding to all or a portion of program logic 150 residing on a server such as web server 108. FIG. 5 further shows another client application 560 corresponding to all or a portion of program logic 150 residing on another client computer such as client 112. FIG. 5 further shows a web server application 570 residing on a web server such as web server 104.

FIG. 5 shows that the client application 540 sends a request 506, such as an HTTP request, for data to the server application 550. The server application 550 sends the appropriate web page data 508, comprising HTML or a scripting code language file or data packet, to the client application 540. The web page data 508 received by the client application 540 is executed by the client application 540 and thereby displayed in an interface, such as shown in web browser 402.

A user enters parameters into the interface provided by web page data 508. The parameters include all such data entered by the user into the web browser 402. The client application 540 subsequently receives the parameters and generates a data construct based on the received data.

The data construct generated by the client application 540 may be HTML or may comprise some or all of the program logic 150, which may be a scripting language such as XML, XSLT, Javascript, etc. The data construct includes computer instructions that, when executed by a client application 540 or 560, sends out a separate request, such as an HTTP request, to each URL entered by the user in web browser 404, wherein each request initiates a display of the defined web site in an interface, such as web browser 204.

Next, the user of the client application 540 sends the data construct (in a data packet such as an email, for example) to another user utilizing client application 560. The client application 560 uses an interface such as a web browser 204 to execute the data construct.

As explained above, the data construct includes computer instructions that, when executed by client application 560, sends out a separate request, such as an HTTP request, to each URL entered by the user in web browser 404, wherein each request initiates a display of the defined web site in an interface, such as web browser 204. Thus, the client application 560 sends out one or more requests, such as HTTP requests 520, to the web server applications 570 of the web sites defined in the data construct. In response to the HTTP requests 520, the web server application 570 for each web server 104-114 sends the appropriate web page data 522, comprising HTML, a scripting code language file or data packet, to the client application 560. The web page data 522 received by the client application 560 is executed by the client application 560 and thereby displayed in the interface, such as web browser 202.

In an embodiment of the present invention, upon display of the web page data 522 by the client application 560, the client application 560 further displays additional information entered by the user in web browser 404. For example, the interface displayed by client application 560 may display for each URL in each tab the comments entered by the user in comment text fields, 412, 422, 432, 442, respectively. The interface displayed by client application 560 may further display for each tab the tab label entered by the user in tab label text field, 413, 423, 433, 443, respectively, for the provision of a tab labels describing the URL. The interface displayed by client application 560 may further display an author of the activation entered by the user in author text field 451, a title of the activation as entered by the user in title text field 452 and a description of the activation as entered by the user in the description text field 453.

The present invention can be realized in hardware, software, or a combination of hardware and software in the system described in the figures above. A system according to a preferred embodiment of the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

An embodiment of the present invention can also be embedded in a computer program product, which comprises all the features enabling the implementation of the methods described herein, and which—when loaded in a computer system—is able to carry out these methods. Computer program means or computer program as used in the present invention indicates any expression, in any language, code or notation, of a set of instructions intended to cause a system having an information processing capability to perform a particular function either directly or after either or both of the following a) conversion to another language, code or, notation; and b) reproduction in a different material form.

A computer system may include, inter alia, one or more computers and at least a computer readable medium, allowing a computer system, to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer readable medium may include, for example, volatile storage such as RAM, buffers, cache memory, and network circuits. Furthermore, the computer readable medium may comprise computer readable information in a transitory state medium such as a network link and/or a network interface, including a wired network or a wireless network that allows a computer system to read such computer readable information.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

We claim:

1. A method for facilitating the simultaneous initiation of a search on a plurality of search engines available over a network, comprising:
receiving from a server a first program logic configured for providing an interface;
executing the first program logic, thereby generating the interface;
reading from the interface a search parameter for conducting a search on a plurality of search engines;
generating a data construct including a second program logic;
executing the second program logic;
responsive to executing the second program logic, sending a separate request to each of the plurality of search engines to conduct a search as defined by the search parameter and sending the search parameter to an ad server;
receiving search results from each of the plurality of search engines;
receiving from the ad server at least one ad corresponding to the search parameter; and
displaying the search results and the at least one ad in a second interface.

2. The method of claim 1, wherein the step of receiving from the server a first program logic comprises:
receiving from the server a first program logic configured for providing an interface, wherein the first program logic comprises scripting language code.

3. The method of claim 2, wherein the step of reading from the interface a search parameter comprises:
reading from the interface a search parameter for conducting a search on a plurality of search engines, wherein the search parameter comprises a text string.

4. The method of claim 3, wherein the step of sending a separate request comprises:
sending a separate HTTP request to each of the plurality of search engines to conduct a search as defined by the search parameter.

5. A computer program product comprising a computer usable medium embodying computer usable program code for facilitating the simultaneous initiation of a search on a plurality of search engines available over a network, the computer program product comprising:
computer usable program code for receiving from a server a first program logic configured for providing an interface;
computer usable program code for executing the first program logic, thereby generating the interface;
computer usable program code for reading from the interface a search parameter for conducting a search on a plurality of search engines;
computer usable program code for generating a data construct including a second program logic;
computer usable program code for executing the second program logic;
computer usable program code for responsive to executing the second program logic, sending a separate request to each of the plurality of search engines to conduct a search as defined by the search parameter and sending the search parameter to an ad server;
computer usable program code for receiving search results from each of the plurality of search engines;
computer usable program code for receiving from the ad server at least one ad corresponding to the search parameter; and
computer usable program code for displaying the search results and the at least one ad in a second interface.

6. The computer program product of claim 5, wherein the computer usable program code for receiving from the server a first program logic comprises:
computer usable program code for receiving from the server a first program logic configured for providing an interface, wherein the first program logic comprises scripting language code.

7. The computer program product of claim 6, wherein the computer usable program code for reading from the interface a search parameter comprises:
computer usable program code for reading from the interface a search parameter for conducting a search on a plurality of search engines, wherein the search parameter comprises a text string.

8. The computer program product of claim 7, wherein the computer usable program code for sending a separate request comprises:
computer usable program code for sending a separate HTTP request to each of the plurality of search engines to conduct a search as defined by the search parameter.

9. A method for facilitating the simultaneous initiation of a plurality of web sites available over a network, comprising:
receiving from a server a first program logic configured for providing an interface;
executing the first program logic, thereby generating the interface;
reading from the interface a plurality of URLs;
generating a data construct including a second program logic, wherein the second program logic includes instructions for sending a separate request to each of the plurality of URLs; and
sending the data construct to a client for execution of the second program logic.

10. The method of claim 9, wherein the step of receiving from the server a first program logic comprises:
receiving from the server a first program logic configured for providing an interface, wherein the first program logic comprises scripting language code.

11. The method of claim 10, wherein the step of reading from the interface comprises:
reading from the interface a plurality of URLs, wherein each URL comprises a text string.

12. The method of claim 11, wherein the instructions for sending a separate request to each of the plurality of URLs comprise:
instructions for sending a separate HTTP request to each of the plurality of URLs.
